(19) United States
(12) Patent Application Publication
(10) Pub. No.: US 2007/0182228 A1
(43) Pub. Date: Aug. 9, 2007

(54) TUBE RECLINER MECHANISM AND SEAT

(76) Inventors: Paul A. Elio, Phoenix, AZ (US); Hari Sankara Iyer, Scottsdale, AZ (US); Robert E. Glaspie, Scottsdale, AZ (US)

Correspondence Address: ROBERT A. PARSONS, 4000 N. CENTRAL AVENUE, SUITE 1220, PHOENIX, AZ, 85012, US

(21) Appl. No.: 11/619,551

(22) Filed: Jan. 3, 2007

Related U.S. Application Data
(60) Provisional application No. 60/757,294, filed on Jan. 9, 2006.

(51) Int. Cl. B60N 2/22

(52) U.S. Cl. 297/354.12

(57) ABSTRACT

A tubular recliner mechanism including an inner tube having a longitudinally extending row of first apertures formed therethrough and an outer tube having a row of longitudinally spaced apart second apertures extending between ends thereof in a rotationally offset pattern. The outer tube is coaxially positioned around and rotatable relative the inner tube. A pin assembly is carried by the inner tube and includes a plurality of pins extending outwardly through the row of first apertures in the inner tube. The recliner mechanism has a locked position wherein rotation of the outer tube relative to the inner tube is prevented and an unlocked position wherein the outer tube can rotate relative to the inner tube. In the locked position at least one of the plurality of pins extends through an aligned second aperture.

### CROSS REFERENCE TO RELATED APPLICATION

This application claims the benefit of U.S. Provisional Patent Application No. 60/757,294, filed Jan. 9, 2006.

### FIELD OF THE INVENTION

The present invention relates to seating systems.

More particularly, the present invention relates to recliner mechanisms for seating systems.

### BACKGROUND OF THE INVENTION

Seating systems can generally be assumed to include a seat bottom and a seat back extending therefrom. Seat backs can be attached to the seat bottom in a fixed position, or pivotally moveable along a range of angles. A seat back pivotally moveable in relation to the seat bottom is often used in vehicles such as cars, trucks, airplanes, and the like. In these instances, the range of movement between the seat back and seat bottom can be extensive, from forwardly angled to fully reclined. Regardless of the extent of the range of movement, included is a recliner mechanism which permits pivotal movement of the seat back and which locks the seat back in the desired position relative to the seat bottom. Many and varied recliner mechanisms have been developed.

In reclining seats, the seat back functions as an extremely long lever arm against which various forces are applied. Any force applied to the seat back, such as from the occupant, vehicle vibration or the like, impose a large moment on the recliner mechanism when applied along such a lengthy lever arm. Any imperfection in the components of the pivot mechanisms, such as play or backlash or tolerances between the mechanism components, may allow the seat back to move a minuscule amount even when the mechanism is locked. These small movements are magnified by the length of the lever arm and become noticeable at the upper end of the seat. This magnified play in recliner mechanisms has been termed “chucking” and refers to any imperfections or play in the mechanism components that allow movement of the seat back while the mechanism is in a locked condition.

Other than chucking, recliner devices often function satisfactorily for the actual reclining function, but function poorly in the area of safety. Typically, when a force of a specific magnitude, such as from a collision, is applied to a seatback the seat has a catastrophic failure. In other words, a seatback remains more or less rigid and supportive until a certain level of force is exceeded. When this level is reached, the recliner mechanism breaks, letting the seatback pivot unrestrained. Once this failure occurs, injury to the occupant of the seat can result. In many automobiles, the space allocated for a recliner mechanism is very limited. By reducing size and costs, current recliner mechanisms are often less than robust and fail at the application of relatively low forces. With the increase of restraint belts attached to the seatback, forces applied to the seat back in a collision will only increase.

It would be highly advantageous, therefore, to remedy the foregoing and other deficiencies inherent in the prior art.

Accordingly, it is an object of the present invention to provide a new and improved seat recliner mechanism.

Another object of the present invention is to provide a robust recliner mechanism with low chuck adjustment.

### SUMMARY OF THE INVENTION

Briefly, to achieve the desired objects and advantages of the present invention in accordance with a preferred embodiment thereof, provided is a tube recliner mechanism including an inner tube having opposing ends and a first aperture formed therethrough intermediate the opposing ends. An outer tube has a plurality of rotationally offset, second apertures therein. The outer tube is coaxially positioned around the inner tube and rotatable relative to the inner tube. The spaced apart second apertures are rotationally offset to provide rotational adjustments of the outer tube relative to the inner tube. A pin assembly is carried by the inner tube and includes a pin extending outwardly through the first aperture in the inner tube. The recliner mechanism has a locked position wherein rotation of the outer tube relative to the inner tube is prevented and an unlocked position wherein the outer tube can rotate relative to the inner tube. In the locked position the pin extends through an aligned second aperture.

The desired objects and advantages of the present invention are further achieved in accordance with another embodiment of a tube recliner mechanism including an inner tube having opposing ends, and a longitudinally extending row of first apertures formed therethrough intermediate the opposing ends. An outer tube has a row of longitudinally spaced apart second apertures extending between ends thereof in a rotationally offset pattern. The outer tube is coaxially positioned around the inner tube and rotatable relative to the inner tube. The spaced apart second apertures are rotationally offset to provide rotational adjustments of the outer tube relative to the inner tube. A pin assembly is carried by the inner tube and includes a plurality of pins extending outwardly through the row of first apertures in the inner tube. The recliner mechanism has a locked position wherein rotation of the outer tube relative to the inner tube is prevented and an unlocked position wherein the outer tube can rotate relative to the inner tube. In the locked position at least one of the plurality of pins extends through an aligned second aperture.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a perspective view of a seat frame with recliner mechanism according to the present invention;

FIG. 2 is an exploded perspective view of a portion of the seat frame and recliner mechanism;

FIG. 3 is an exploded perspective view of the recliner mechanism;

FIG. 4 is a partial end perspective view of the recliner mechanism;

FIG. 5 is a perspective view of the pin assembly;

FIG. 6 is a perspective view of the recliner mechanism of the present invention;

FIG. 7 is an enlarged perspective end view of the recliner mechanism of FIG. 6;

FIG. 8 is a perspective end view of the recliner mechanism with the handle and lift plate in the locked position;

FIG. 9 is a perspective end view of the recliner mechanism with the handle and lift plate in the unlocked position;

FIG. 10 is a perspective exploded view of the seat frame with recliner mechanism;

FIG. 11 is a bottom view of the seat frame with recliner mechanism;

FIG. 12 is an enlarged sectional view taken along line 12-12 of FIG. 1;

FIG. 13 is an exploded perspective view of another embodiment of a recliner mechanism;

FIG. 14 is a side view of a recliner seat with tube recliner mechanism;

FIG. 15 is a perspective view of the seat of FIG. 14;

FIG. 16 is an enlarged perspective view of the tube recliner mechanism of FIGS. 14 and 15;

FIG. 17 is an exploded view of the tube recliner of FIGS. 14-16;

FIG. 18 is a simplified sectional side view of a portion of the tube recliner of FIG. 17;

FIG. 19 is an exploded view of yet another embodiment of a tube recliner according to the present invention;

FIG. 20 is an enlarged sectional view of the embodiment illustrated in FIG. 19, in a locked position;

FIG. 21 is an enlarged sectional view of the embodiment illustrated in FIG. 19, in a unlocked position;

FIG. 22 is a schematic representation of a pin illustrating a preferred construction thereof;

FIG. 23 is a partial perspective view illustrating an aperture arrangement;

FIG. 24 is a partial perspective view of another embodiment of a tube recliner with a rack and pinion system;

FIG. 25 is an end view of the tube recliner of FIG. 24; and

FIG. 26 is an exploded perspective view of the tube recliner mechanism of FIG. 24.

### DETAILED DESCRIPTION OF PREFERRED EMBODIMENTS

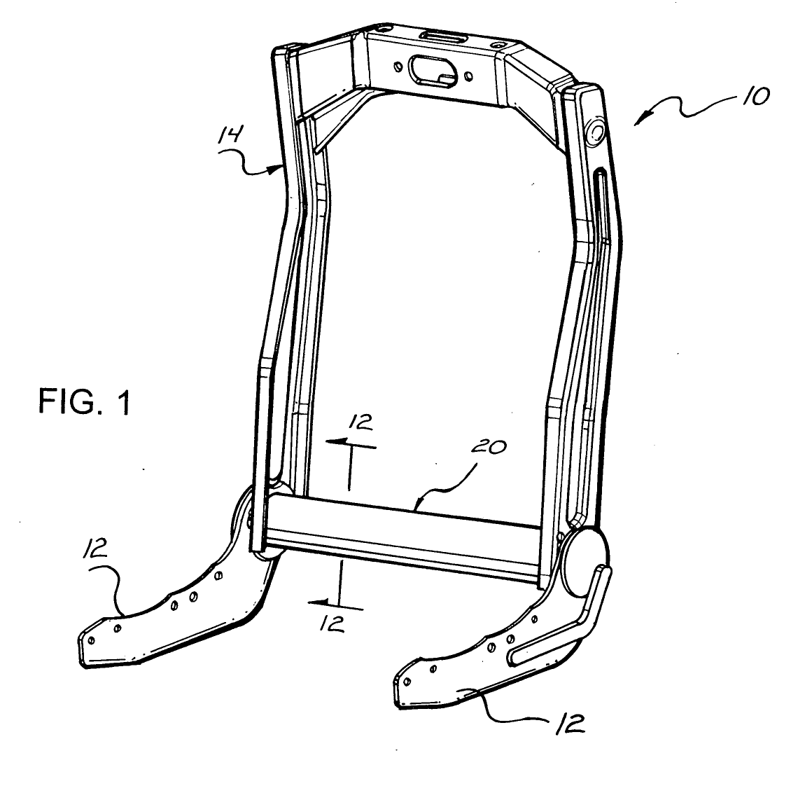

Turning now to the drawings, in which like reference characters indicate corresponding elements throughout the several views, attention is first directed to FIG. 1 which illustrates a seat frame generally designated 10. In the preferred embodiment, seat frame 10 is a portion of a seating system for use in a vehicle seat such as a driver seat, passenger seat, bench seat, rear seat and the like. It will also be understood that while a vehicle seat (car seat, truck seat, airplane seat and the like) is illustrated, the seat frame of the present invention can be employed in any seating system having a movable back.

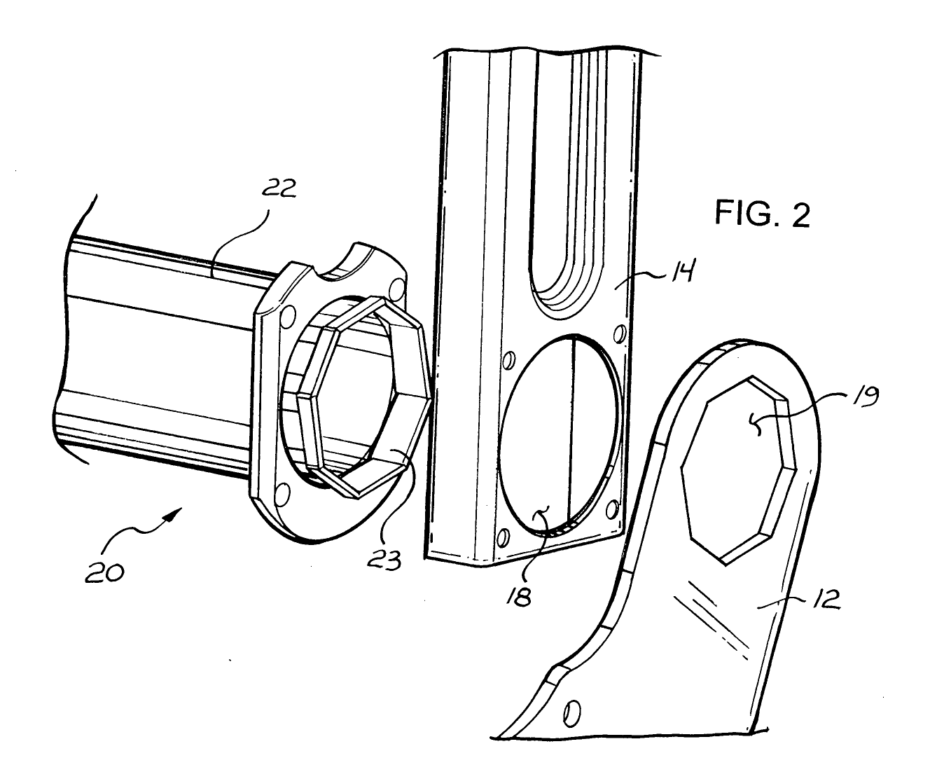

Seat frame 10 includes risers 12 mountable to a support base such as tracks and the like as will be shown in subsequent embodiments, a back frame 14, and a tube recliner mechanism 20 movably coupling back frame 14 to risers 12. Risers 12 are mountable to a support base, which will typically include a seat bottom not specifically shown. With additional reference to FIG. 2, tube recliner mechanism 20 includes an outer tube 22 coupled to back frame 14 and an inner tube 23 coupled to risers 12. As will be described presently, tube recliner mechanism 20 is movable between a locked position and an unlocked position. In the unlocked position outer tube 22 rotates in relation to inner tube 23 thereby adjusting the relative angular position of back frame 14 to risers 12. It should be understood by one skilled in the art that while outer tube 22 and inner tube 23 are coupled to back frame 14 and risers 12, respectively, in this embodiment, it is contemplated that their attachments can be reversed.

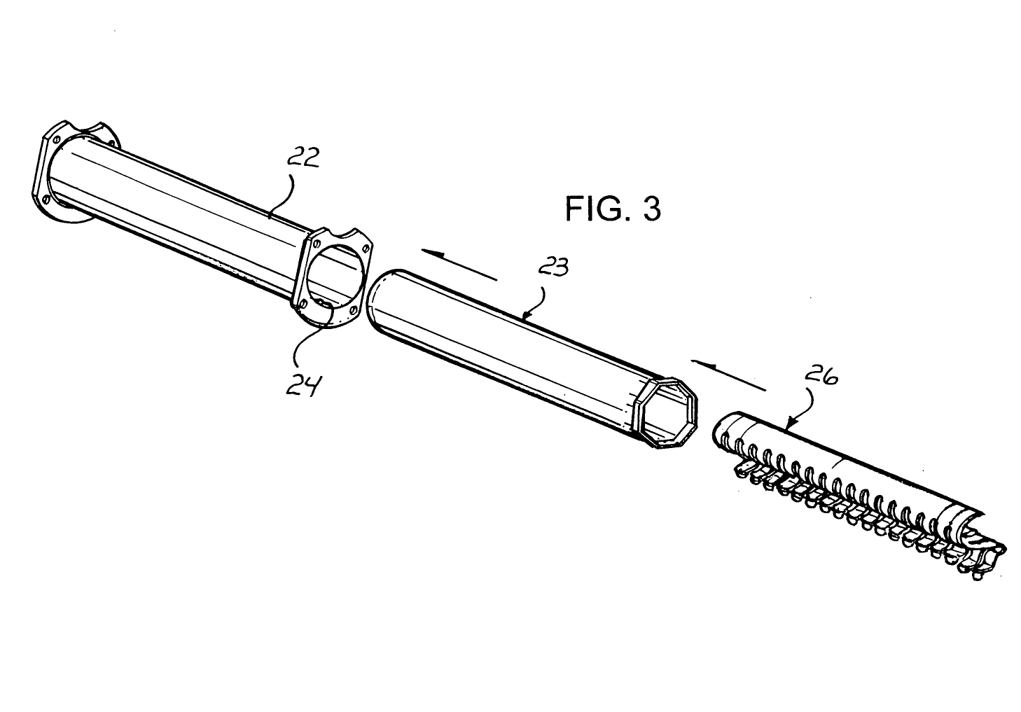

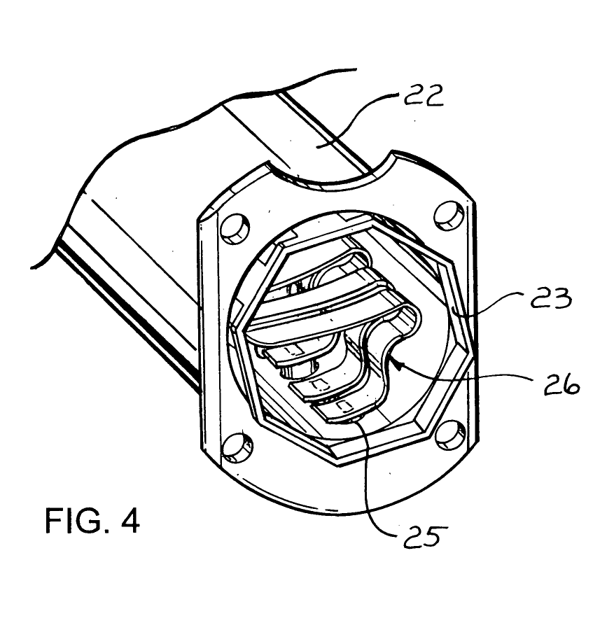

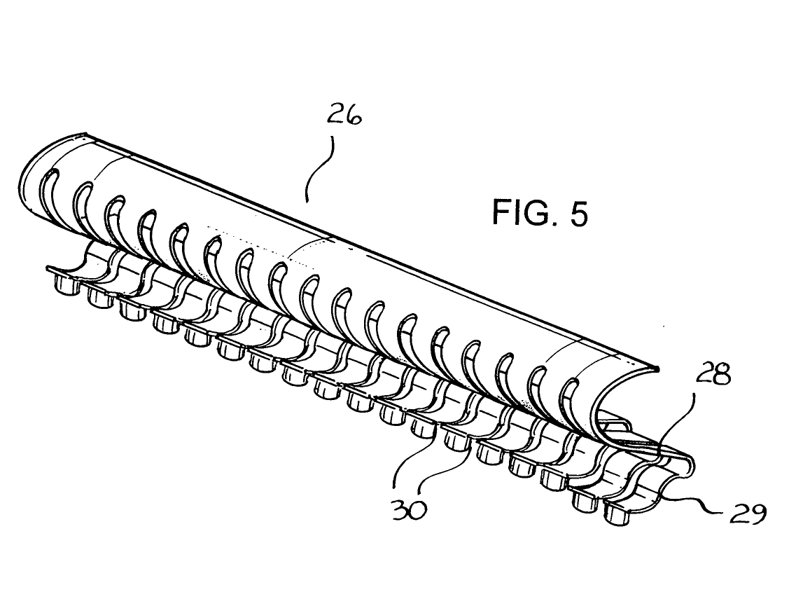

Turning now to FIGS. 3-7, recliner mechanism 20 is illustrated in greater detail. Recliner mechanism 20 includes outer tube 22 having a row of longitudinally spaced apart apertures 24 extending between ends thereof in a rotationally offset pattern, which allows for an increment of rotational adjustments between outer tube 22 and inner tube 23. The term “rotational adjustment” means the rotational position of inner tube 23 relative to outer tube 22. The term “rotationally offset” means apertures 24 are offset around the circumference of outer tube 22. In this embodiment, apertures 24 are rotationally offset by being formed in a longitudinally extending slightly helical arc designed to provide rotational adjustments in specific steps, preferably to provide steps of 2° adjustments. In another embodiment (not shown), rotationally offset can be provided by spacing apertures 24 apart in a circular arrangement (e.g. spaced apart about the circumference in a common plane). Inner tube 23 includes a row of longitudinally spaced apart apertures 25 extending longitudinally from end to end in a generally linear spaced apart manner. One skilled in the art will understand that single or multiple rows of apertures 24 and apertures 25 may be employed as desired.

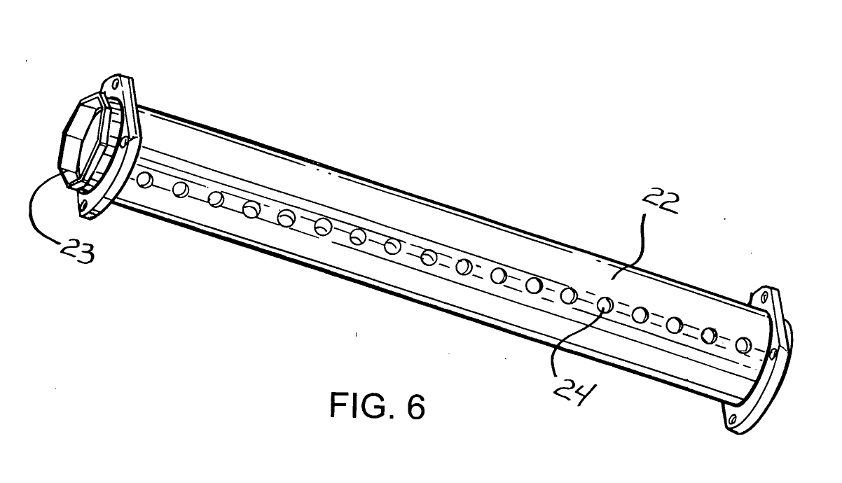

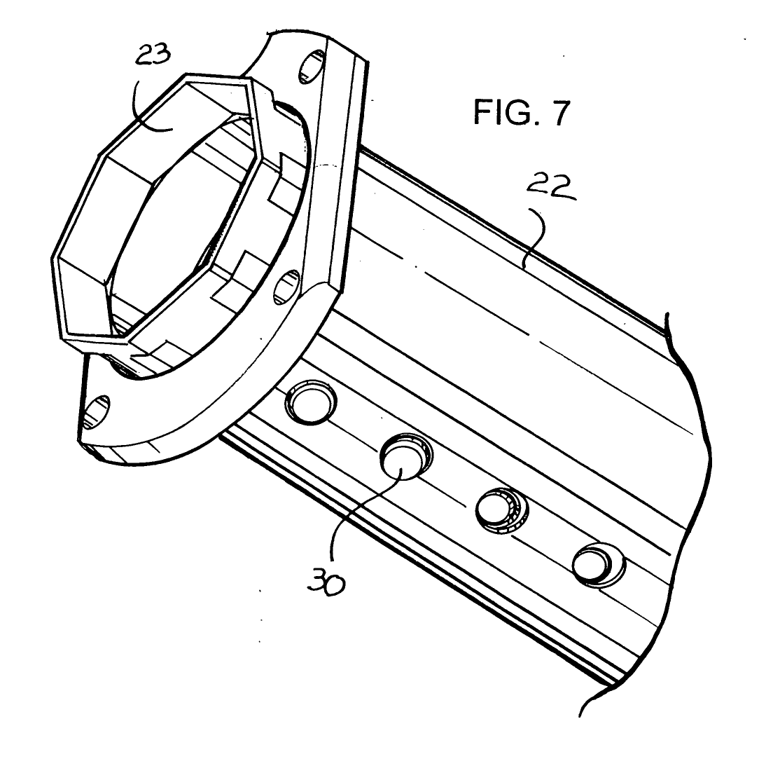

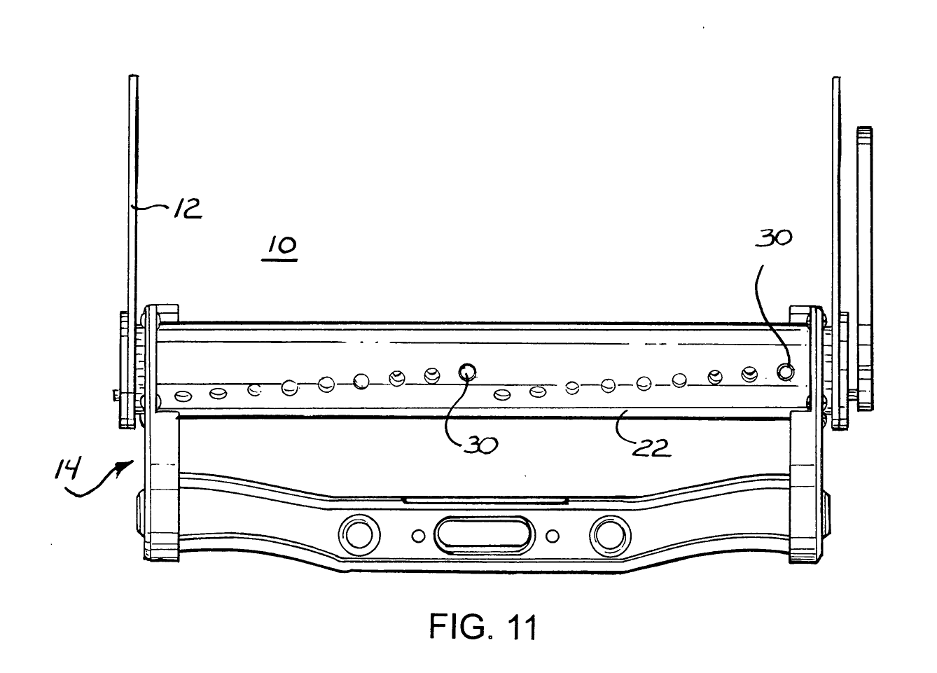

A pin assembly 26 is received within inner tube 23 and movable between a retracted and extended position. A pin assembly can be substantially any mechanism for moving the pins between the retracted and extended positions, such as a cam system, a rack and pinion system, a spring systems and the like. Assembly 26, in this specific embodiment, includes a spring structure 28 with a plurality of radially outwardly biased spring fingers 29. Each spring finger 29 supports a radially outwardly extending pin 30, thus providing a plurality of linearly spaced pins 30. Multiple sets of pins may be employed depending on the number of rows of apertures 24 and 25 utilized. In the extended position, spring fingers 29 of spring structure 28 biases each pin 30 radially outwardly into an aperture 25 of inner tube 23. Depending upon the relative rotary position of inner tube 23 with respect to outer tube 22, some of pins 30 extend radially outwardly through apertures 25 into apertures 24 of outer tube 22 aligned therewith. As can be seen with specific reference to FIGS. 6 and 7, one or more pins 30 extending through apertures 25 of inner tube 23 are aligned with and extend into apertures 24 of outer tube 22. If multiple rows of apertures 24 are employed, additional pins 30, corresponding to those rows, will extend through apertures 24 of the multiple rows (see FIG. 11).

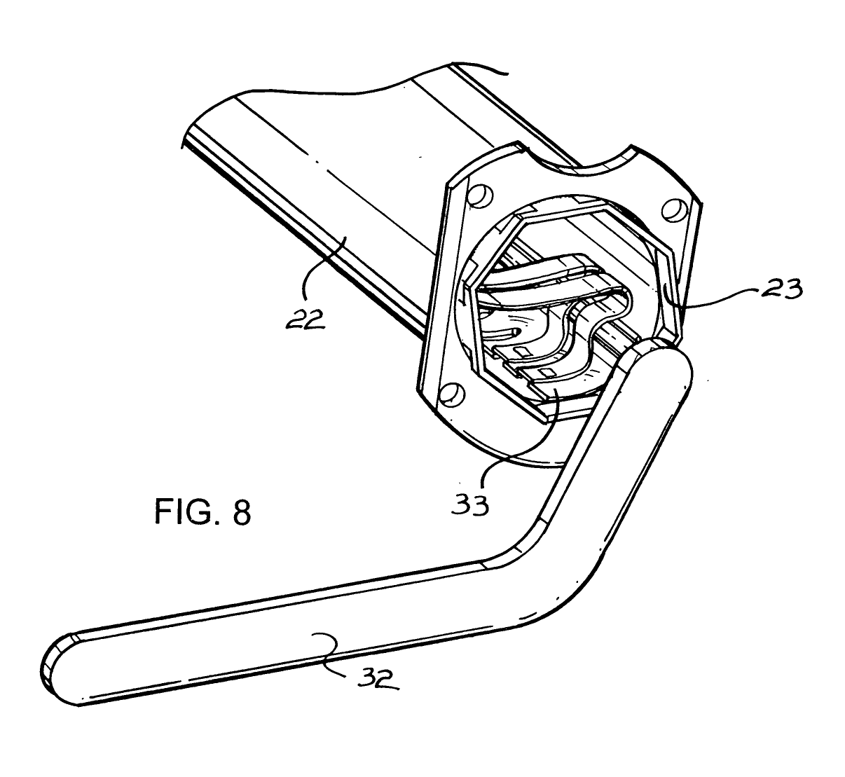

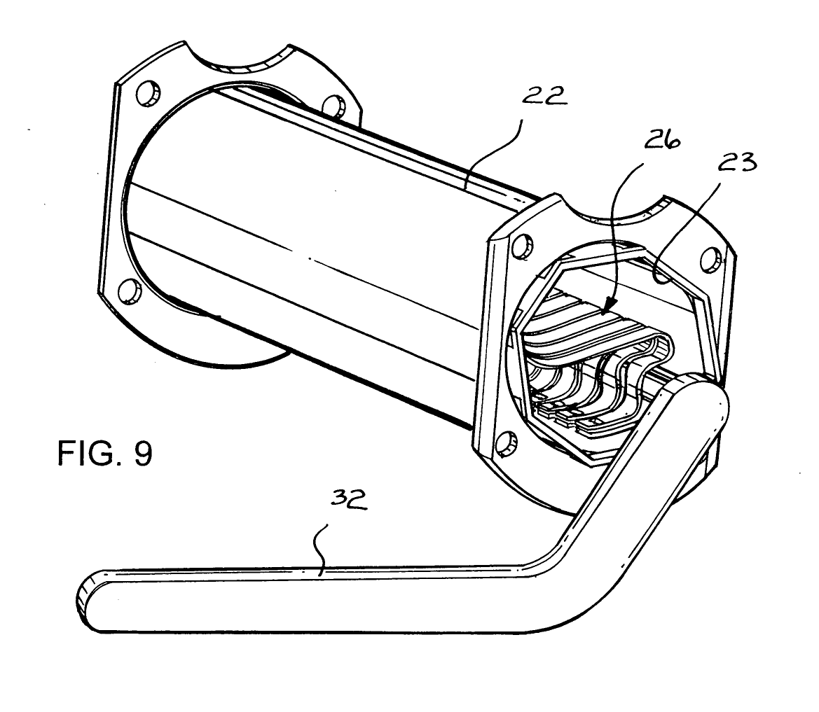

Referring now to FIGS. 8 and 9, recliner mechanism 20 further includes a handle 32 coupled to an operating structure, which in this embodiment is a lift plate 33. Lift plate 33 extends through inner tube 23 and engages spring fingers 29 of spring structure 28. As can be seen in FIG. 8, when handle 32 is down, pins 30 are biased radially outwardly through aligned apertures 24 and 25 by spring fingers 29 of spring structure 28 into the extended position which places the recliner mechanism in the locked position. When handle 32 is in the raised position as seen in FIG. 9, plate 33 forces spring fingers 29 of spring structure 28 radially inwardly into the retracted position which places the recliner mechanism in the unlocked position. Moving spring structure 28 into the retracted position removes pins 30 from aligned apertures 24. In the retracted position with pins 30 retracted, relative rotation of outer tube 22 with respect to inner tube 23 is possible and the recliner mechanism is unlocked.

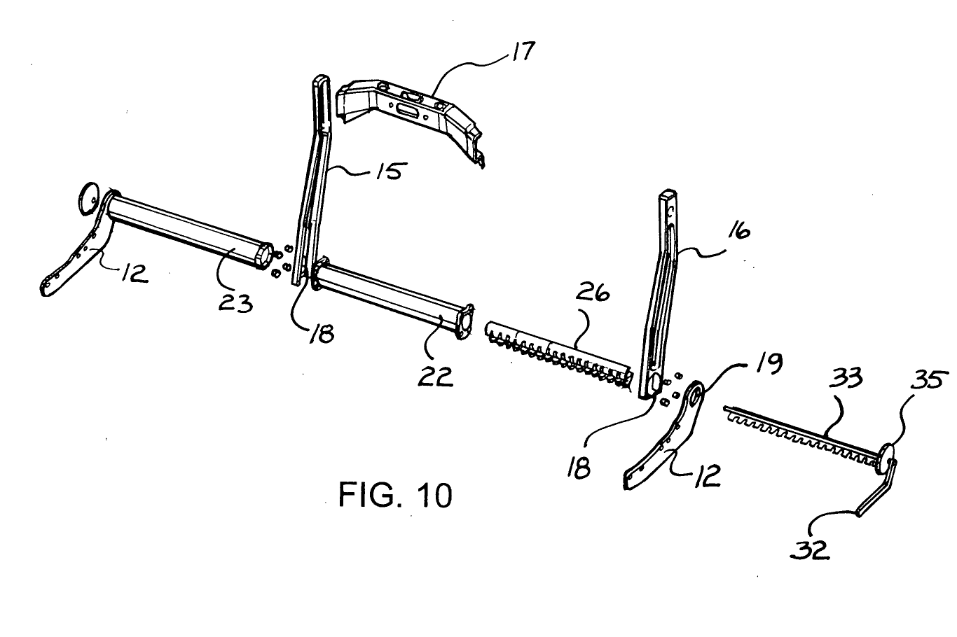

Referring now to FIG. 10, an exploded view of seat frame 10 is illustrated showing the relative positioning of the previously described elements. Specifically, back frame 14, including side beams 15 and 16 each coupled at a lower end to opposing ends of outer tube 22 extending therebetween. A head rest piece 17 is coupled between upper ends of side beams 15 and 16. Side beams 15 and 16 are coupled to outer tube 22 by any convenient fastening member such as screws, bolts, welds, and the like, and are coupled by rivets in this embodiment. Apertures 18 are formed in the lower ends of side beams 15 and 16 in alignment with the ends of outer tube 22. In this manner, inner tube 23 can be received concurrently through apertures 18 of side beams 15 and 16 and through outer tube 22. Risers 12 each include apertures 19 received about opposing ends of inner tube 23 and generally aligned with apertures 18. Since risers 12 do not pivot, and are held immobile, inner tube 23 is held immobile by engagement therewith. This can be accomplished by fastening members such as rivets, welds, pins, screws and the like, or as in this embodiment, by employing mating facets or flats on the ends of inner tube 23 and apertures 19. Pin assembly 26 is received concurrently through apertures 18 and 19 and inner tube 23. Lift plate 33 is received in inner tube 23 through apertures 18 and 19 with handle 32 accessible outside thereof. End caps 35 can be employed to close apertures 19.

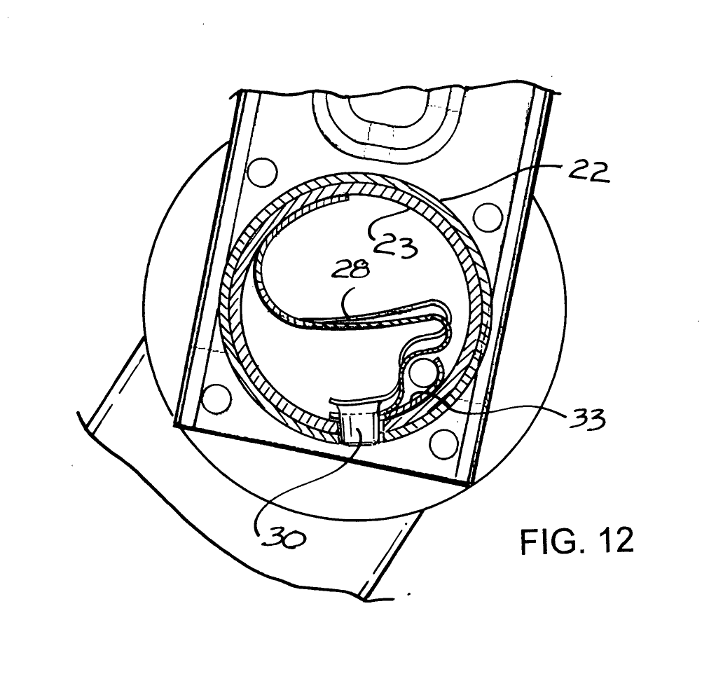

FIG. 11 is a bottom view of seat frame 10 illustrating multiple rows of apertures 24 in outer tube 22. By providing two rows of apertures 24, two pins 30 of the pins extending through the single row of apertures 25 of inner tube 22, in this embodiment, extend through two apertures 24 of outer tube 22. FIG. 12 is a sectional side view illustrating pin 30 extending through aligned apertures 24 and 25. Also illustrated is lift plate 33 capable of moving spring structure 28 to a retracted position, thereby removing pin 30 from the aligned apertures.

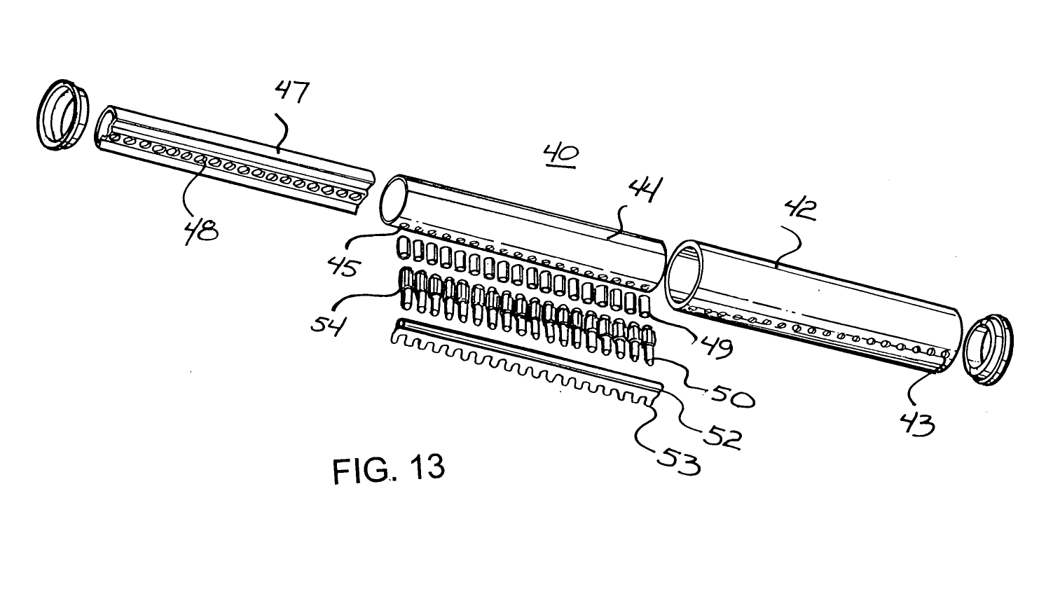

Turning now to FIG. 13, another embodiment of a tube recliner mechanism generally designated 40 is illustrated wherein pins are movable between an extended, locked position radially extending through apertures in the inner tube and the outer tube and a retracted, unlocked position with the pins retracted from the apertures in the outer tube. As with mechanism 20, tube recliner mechanism 40 includes an outer tube 42 having a plurality of apertures 43 extending between ends thereof in a rotationally offset pattern which allows for incremental rotational adjustments, and inner tube 44 having a plurality of apertures 45 in a linear arrangement between ends thereof. In this embodiment, a pin assembly includes a holder 47 defining a plurality of sockets 48 in each of which is received a compression spring 49 and associated pin 50. The pin assembly is received within inner tube 44 such that each of pins 50 is aligned with apertures 45. A lift plate 52 includes a plurality of fingers 53 engaging shoulders 54 formed on pins 50. In a locked position compression springs 49 bias pins 50 through apertures 45 and into aligned apertures 43 of outer tube 42. In an unlocked position lift plate 52 is pivoted such that fingers 53 press against shoulders 54, forcing pins 50 into sockets 48 against the bias of compression springs 49. This removes pins 50 from apertures 43, permitting relative movement of outer tube 42 with respect to inner tube 44. Upon achieving the desired position, lift plate 52 is moved to the locked position wherein pins 50 extend into apertures 45 and newly aligned apertures 43.

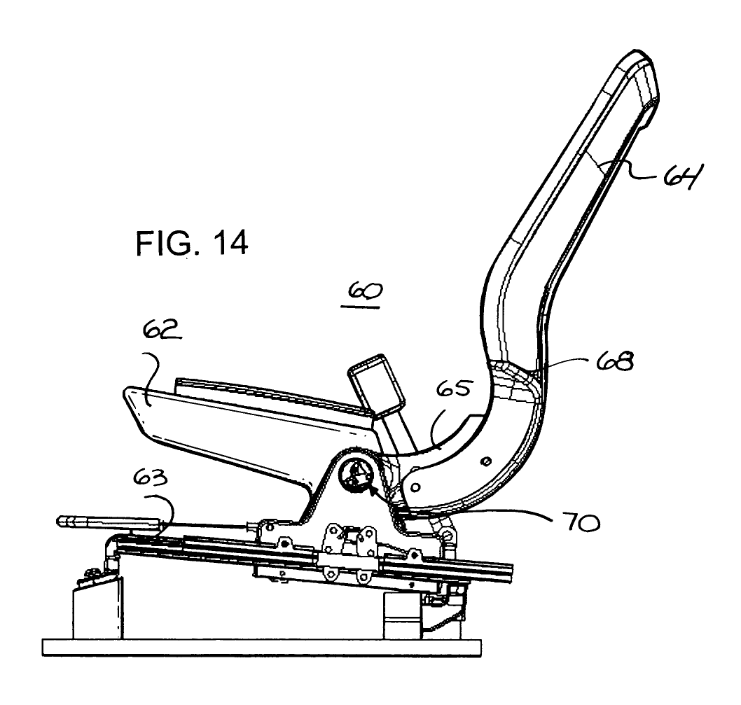

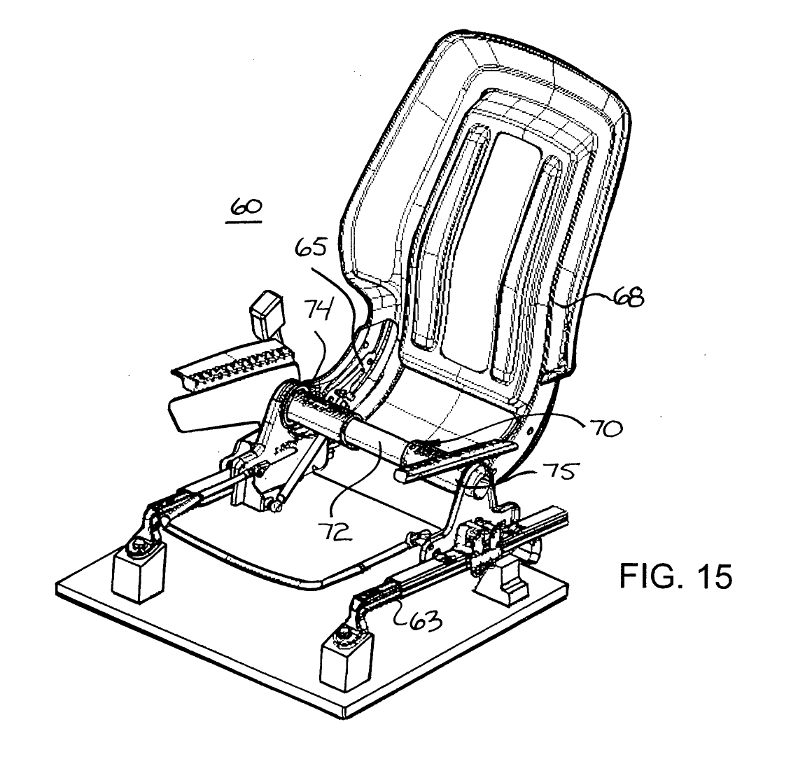

Turning now to FIGS. 14 and 15, a seat 60 is illustrated. Seat 60 includes a seat bottom 62 mounted to a support base such as tracks 63, a seat back 64, and a tube recliner mechanism 70 pivotally coupling seat back 64 to seat bottom 62. As in previously described embodiments, seat bottom 62 includes risers 65, and seat back 64 includes a back frame 68. Recliner mechanism 70 incorporates an inner tube 72 coupled to back frame 68 and an outer tube. In this embodiment, the outer tube includes an outer tube portion 74 and an outer tube portion 75, each received on opposing ends of inner tube 72 and each coupled to one of risers 65. Each end of inner tube 72 receives a pin assembly movable between a locked and an unlocked position.

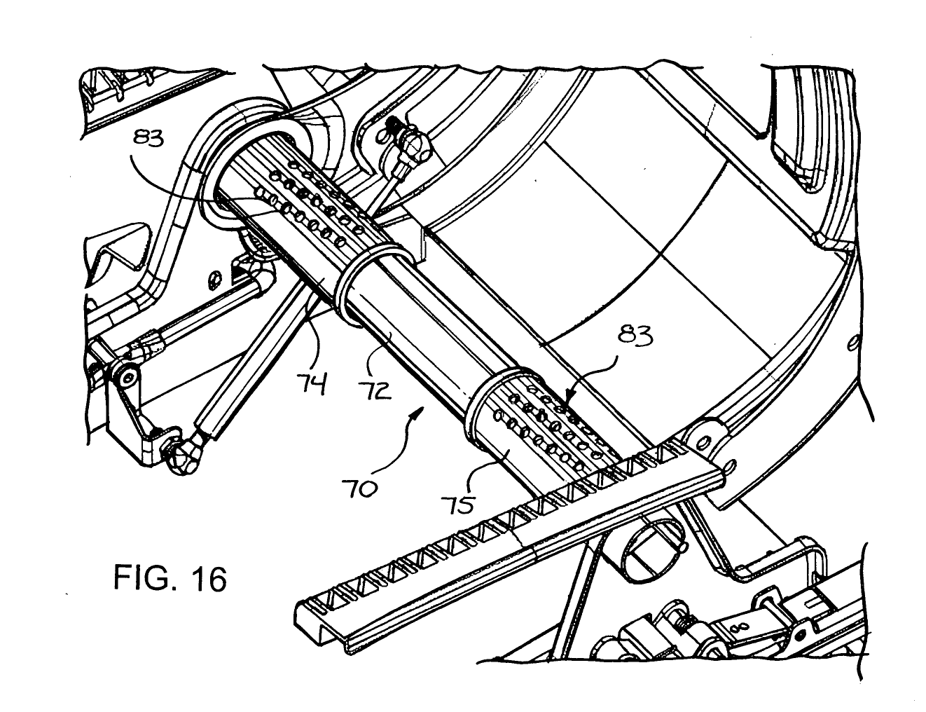

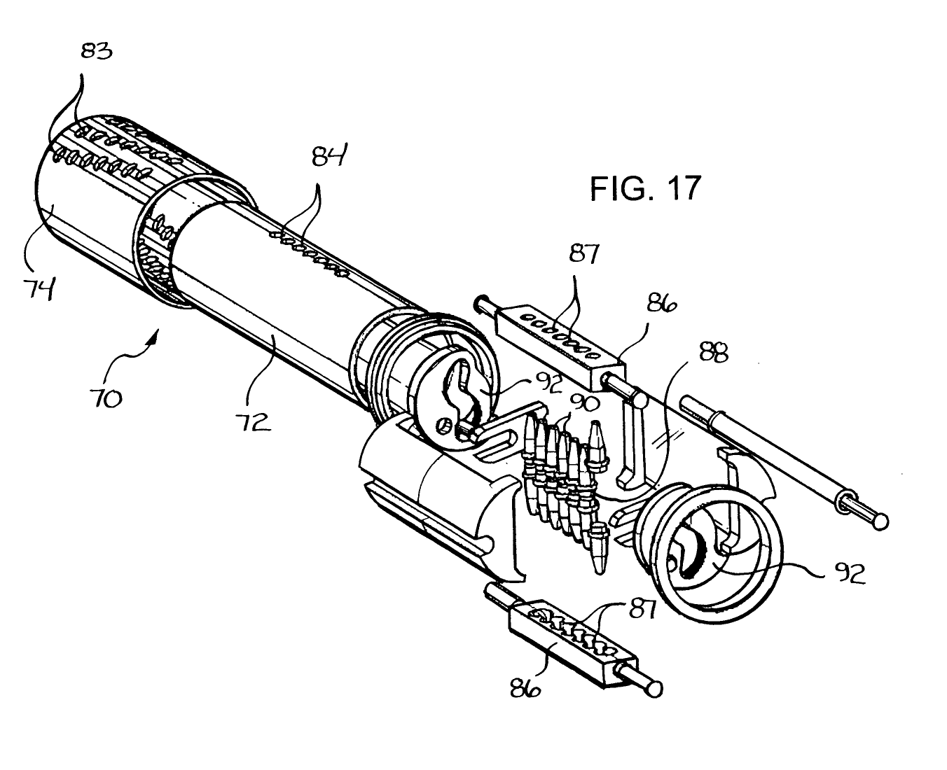

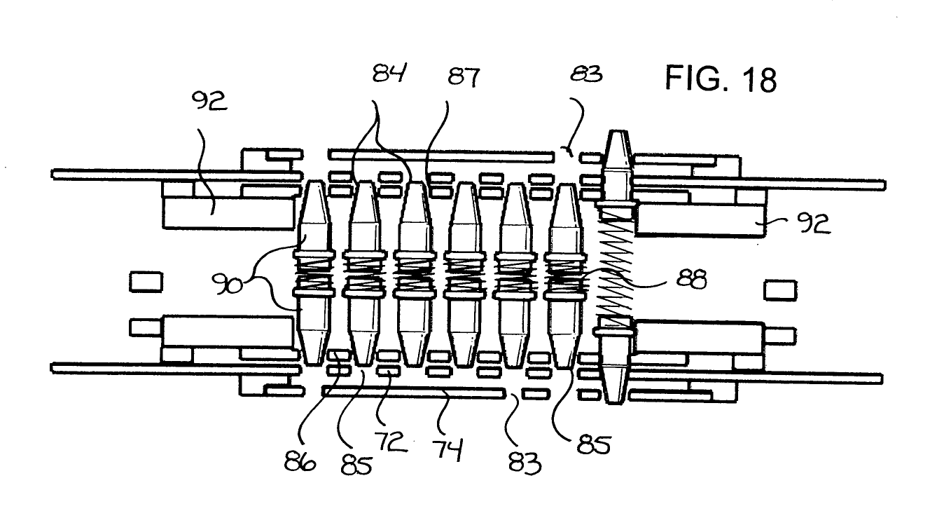

With additional reference to FIGS. 16, 17 and 18, tube recliner mechanism 70 includes the outer tube having a plurality of apertures. Outer tube portions 74 and 75 of the outer tube each have multiple rows of spaced apart apertures 83 extending between ends thereof in a rotationally offset pattern, which allows for increments of rotational adjustment. Inner tube 72 has a plurality of apertures 84 in a linear arrangement extending inwardly from each end thereof, corresponding to the location of outer tube portions 74 and 75. While a single row of apertures 84 can be employed, inner tube 72 of mechanism 70 includes another row of apertures 85 (see FIG. 18) extending in a linear arrangement inwardly from each end thereof, diametrically opposed to apertures 84.

As with previous embodiments, a pin assembly is carried within inner tube 72. In this embodiment, however, two opposing rows of pins are employed. The pin assembly includes a pair of pin racks 86 defining a plurality of opposing sockets 87. Pin racks 86 are movable toward and away from each other. Opposing pins 90, pairs of which are movable between a retracted and an extended position by intermediate compression springs 88, are received in opposing sockets 87 of pin racks 86. The retracted and extended positions correspond to recliner mechanism 70 being in the unlocked and locked configuration, respectively. The pin assembly is received within inner tube 72 such that each of opposing pins 90 is aligned with opposing apertures 84 and 85. A cam mechanism 92 compresses and allows expansion of pins 90 against the bias of springs 88 by forcing pin racks 86 between their retracted and extended positions. In the locked position, compression springs 88 bias opposing pins 90 through apertures 84 and 85 and into aligned apertures 83 of outer tube portions 74 and 75. Multiple pins 90 on the same side can engage since there are multiple rows of apertures 83 which may align. An unlocked cam mechanism 92 is pivoted such that pin racks 86 are moved toward one another into the retracted position, forcing pins 90 inwardly against the bias of compression springs 88. This removes pins 90 from apertures 83, permitting relative movement of outer tube portions 74 and 75 with respect to inner tube 72. Upon achieving the desired position, cam mechanism 92 is moved to the locked position wherein pins 90 extend through apertures 84 and 85 into newly aligned apertures 83.

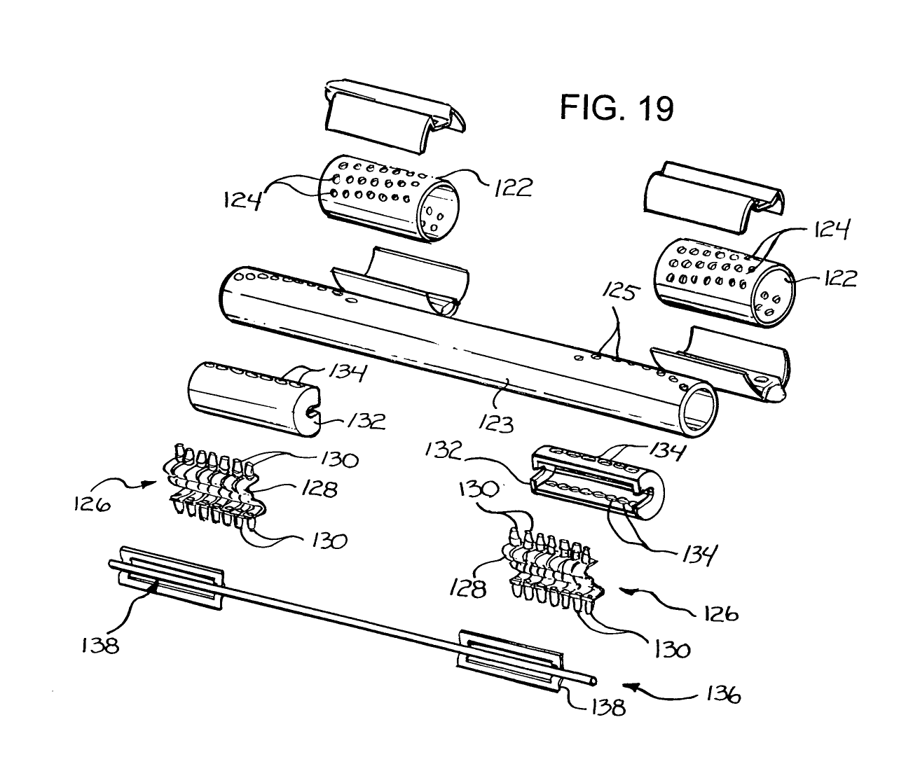

Turning now to FIG. 19, another embodiment of a tube recliner mechanism generally designated 120 is illustrated. Recliner mechanism 120 includes an outer tube consisting of two portions 122 each having a plurality of rows of apertures 124 each row extending between ends thereof in a rotationally offset pattern, which allows for incremental rotational adjustments between outer tube 122 and an inner tube 123. Apertures 124 are formed in a slightly helical arc preferably to provide, for example, 2° of adjustment. Inner tube 123 includes a pair of diametrically opposed rows of apertures 125 extending in a linear manner from each end inwardly, corresponding to the position of outer tube portions 122.

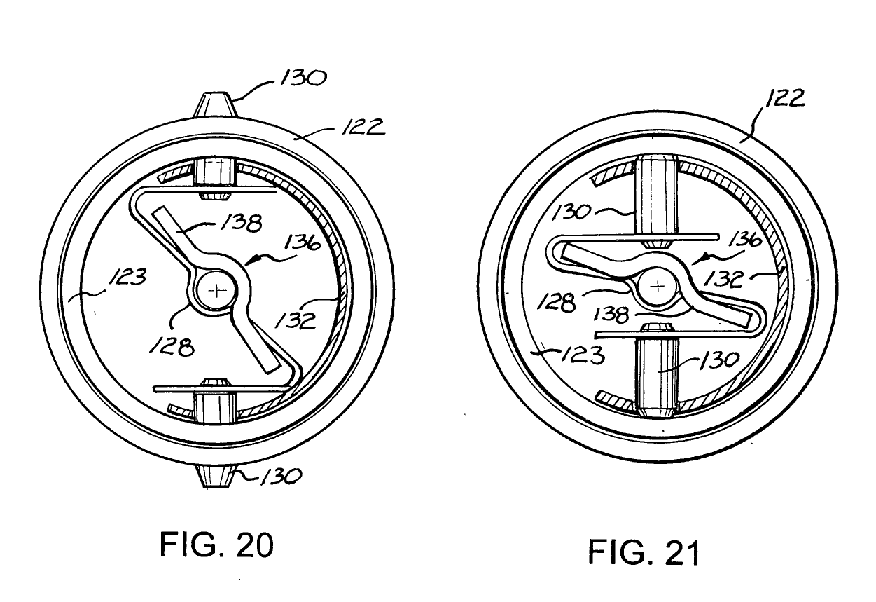

A pin assembly 126 is received within inner tube 123 and movable between a retracted and extended position. Assembly 126, in this specific embodiment, includes a spring structure 128 supporting a plurality of opposed linearly spaced pins 130. A pin guide 132 including a plurality of opposed openings 134 carried spring structure 128 and pins 130 with pins 130 extending through openings 134. A pin guide 132 carried spring structure 128 and pins 130 within each end of inner tube 123. Pin guides 132 maintain alignment of pins 130 with apertures 125 of inner tube 123 when moved between the extended (locked position see FIG. 20) and retracted positions (unlocked position see FIG. 21). In the extended position, spring structure 128 biases pins 130 radially outwardly into apertures 125 of inner tube 123. Depending upon the relative position of inner tube 123 with respect to outer tube 122, some of pins 130 extend radially outwardly through apertures 125 into those of apertures 124 aligned therewith.

With additional reference to FIGS. 20 and 21, recliner mechanism 120 further includes a handle (not shown) coupled to a flapper assembly 136. Flapper assembly 136 extends through inner tube 123 and includes flapper ends 138, which engage spring structure 128. As can be seen in FIG. 20, when flapper assembly 136 is rotated to the locked position spring assembly 128 biases pins 130 radially outwardly through aligned apertures 124 and 125. When flapper assembly 136 is rotated to the unlocked position, as seen in FIG. 21, spring structure 128 is compressed, retracting pins 130 from apertures 124 of outer tubes 122.

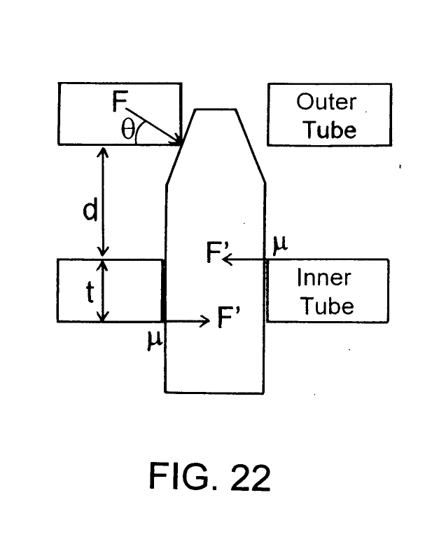

Turning now to FIG. 22, a schematic representation of a pin (any of the pins described in the embodiments described previously) illustrates a preferred construction thereof. The pins are generally cylindrical with a frusto-conical end to be received through the aligned apertures of the inner tube and the outer tube. The end can have a particular geometry to prevent back driving resulting in unintentional unlocking of the recliner mechanism. To determine the geometry of the pin, the following equations were developed:
F d cos(θ)=F′t (i)
F sin(θ)=2μF′ (ii)

Substituting equation (i) in equation (ii)
d≧t tan(θ)20μ (iii)

Where: t=the inner tube thickness;
d=pin contact distance;
θ=pin taper angle;
μ=coefficient of friction; and
F, F′=contact forces.

As long as d is greater than or equal to the expression on the right of equation (iii) the pin will not back drive.

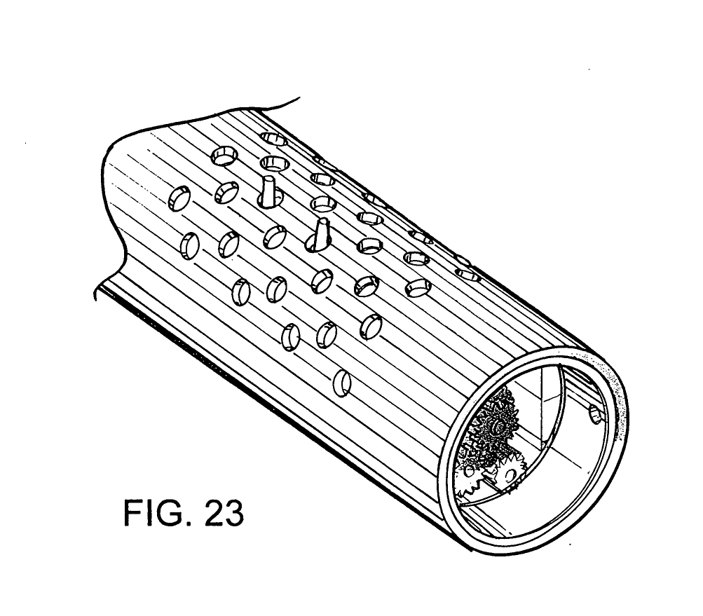

Turning now to FIG. 23, many arrangements of apertures are contemplated as long as the apertures in that arrangement have some degree of rotational offset. The offset can be between adjacent apertures, or in a randomly configured arrangement so as to increase spacing between apertures to provide increased structural integrity and to permit substantially infinite adjustments. It should be understood that any arrangement of aperture that provides a desired degree of movement can be employed as long as those apertures, however positioned, have a degree of rotational offset to permit adjustment. Multiple apertures may have the same rotational offset to provide multiple engagements for strength.

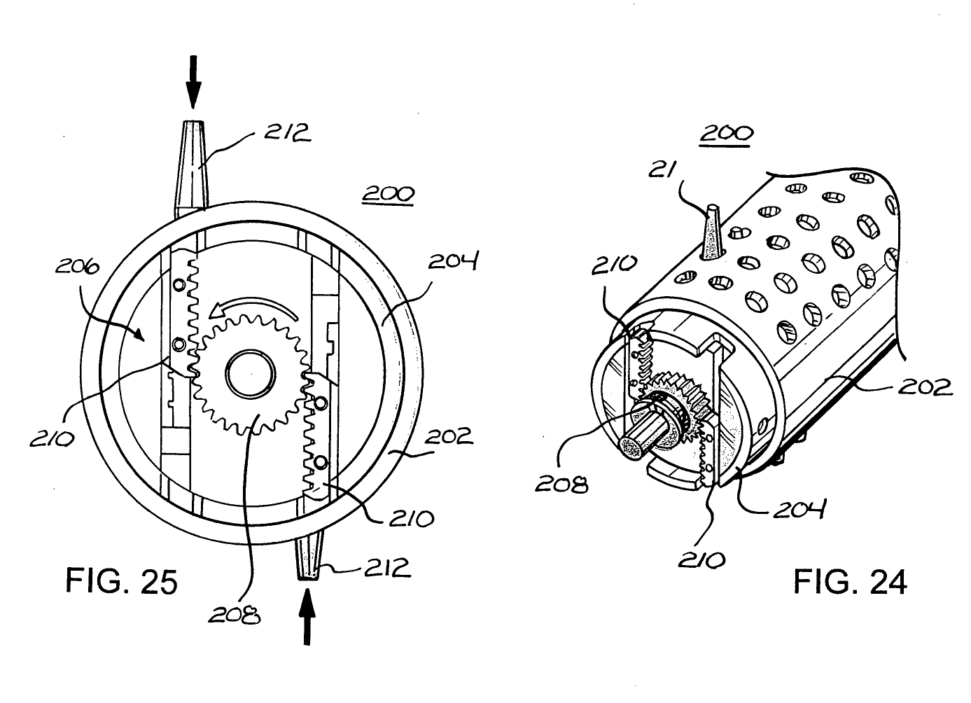

Referring to FIGS. 24 and 25, a tube recliner mechanism 200 is illustrated. Mechanism 200 includes an outer tube 202, an inner tube 204 similar to those described previously, and a pin assembly 206 carried within inner tube 204. In this specific embodiment, pin assembly 206 includes a centrally located pinion gear drive 208 with racks 210 movably engaged on opposing sides thereof. Racks 210 carry pins 212 for movement between retracted and extended (FIGS. 24 and 25) positions. While it can be seen that in this embodiment pins 212 are offset from a radius of outer tube 202, it should be understood that pins 212 move radially outwardly when moved from the retracted to the extended position.

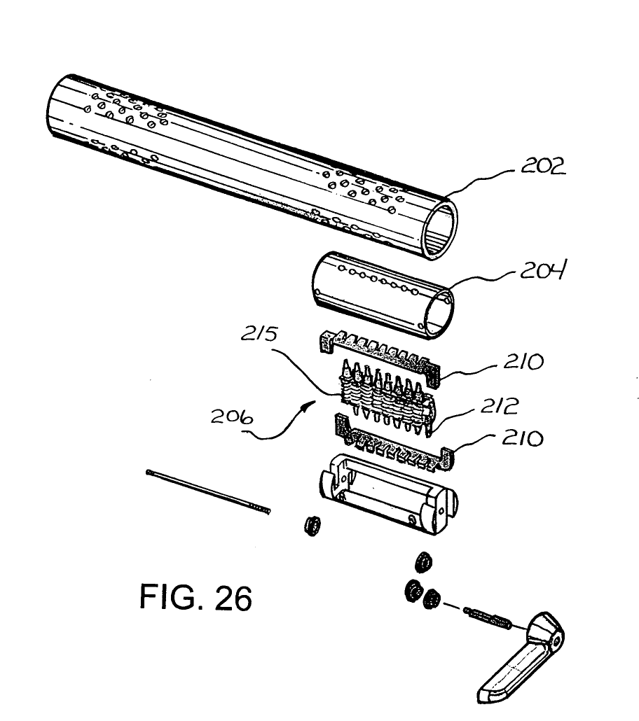

With additional reference to FIG. 26, it can be seen that pin assembly 206 includes a plurality of springs 215 biasing pins 212 outwardly. In the extended position the rack and pinion system permits springs 215 to bias those pins 212 through aligned apertures. In the retracted position, the rack and pinion system urges pins 212 inwardly against the bias.

The invention has been described above with reference to preferred embodiments. However, those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A tube recliner mechanism comprising:
an inner tube having opposing ends and a first aperture formed through the inner tube intermediate the opposing ends;
an outer tube having a plurality of rotationally offset, second apertures therein, the outer tube being coaxially positioned around the inner tube and rotatable relative to the inner tube, the spaced apart second apertures being rotationally offset to provide rotational adjustments of the outer tube relative to the inner tube;
a pin assembly carried by the inner tube and including a pin extending outwardly through the first aperture in the inner tube; and
the recliner mechanism having a locked position wherein rotation of the outer tube relative to the inner tube is prevented and an unlocked position wherein the outer tube can rotate relative to the inner tube, in the locked position the pin extends through an aligned second aperture.

2. A tube recliner mechanism as claimed in claim 1 wherein the inner tube includes a plurality of first apertures and the pin assembly includes a pin extending outwardly through each of the plurality of first apertures.

3. A tube recliner mechanism as claimed in claim 2 wherein the plurality of second apertures are positioned in a longitudinally extending pattern.

4. A tube recliner mechanism as claimed in claim 3 wherein the plurality of second apertures are positioned in a longitudinally extending slightly helical arc.

5. A tube recliner mechanism as claimed in claim 1 wherein the pin assembly includes a structure biasing the outwardly extending pin through the first aperture and into an aligned one of the second apertures.

6. A tube recliner mechanism as claimed in claim 5 wherein the structure biasing the pin includes a spring structure.

7. A tube recliner mechanism as claimed in claim 5 further including an operating structure positioned to move the pin assembly between an extended position and a retracted position, the operating structure moving the pins against the biasing structure in the retracted position.

8. A tube recliner mechanism comprising:
an inner tube having opposing ends, a longitudinally extending row of first apertures formed through the inner tube intermediate the opposing ends;
an outer tube having a row of longitudinally spaced apart second apertures extending between ends thereof in a rotationally offset pattern, the outer tube being coaxially positioned around the inner tube and rotatable relative to the inner tube, the spaced apart second apertures being rotationally offset to provide rotational adjustments of the outer tube relative to the inner tube;
a pin assembly carried by the inner tube and including a plurality of pins extending outwardly through the row of first apertures in the inner tube; and
the recliner mechanism having a locked position wherein rotation of the outer tube relative to the inner tube is prevented and an unlocked position wherein the outer tube can rotate relative to the inner tube, in the locked position at least one of the plurality of pins extends through an aligned second aperture.

9. A tube recliner mechanism as claimed in claim 8 wherein the pin assembly includes a structure biasing the plurality of pins through the first apertures and into an aligned one of the second apertures.

10. A tube recliner mechanism as claimed in claim 9 wherein the structure biasing the plurality of pins includes a spring structure.

11. A tube recliner mechanism as claimed in claim 9 further including an operating structure positioned to move the pin assembly between an extended position and a retracted position, the operating structure moving the plurality of pins against the biasing structure in the retracted position.

12. A tube recliner mechanism as claimed in claim 8 wherein the outer tube includes a plurality of rows of second apertures.

13. A tube recliner mechanism as claimed in claim 12 wherein the inner tube includes a plurality of rows of first apertures.

14. A tube recliner mechanism as claimed in claim 8 wherein the outer tube includes a first portion and a second portion each being coaxially positioned around the opposing ends of the inner tube and rotatable relative thereto, the first portion and the second portion of the outer tube each include portions of the row of longitudinally spaced apart second apertures in a rotationally offset pattern.

15. A reclining seat comprising:
risers mountable to a support base;
a back frame; and
a tube recliner mechanism movably coupling the back frame to the risers, the tube recliner mechanism having a locked position and an unlocked position, the tube recliner mechanism comprising:
an inner tube coupled to one of the back frame and the risers;
an outer tube coupled to an other of the risers and the back frame, the outer tube being coaxially positioned over the inner tube for relative rotational adjustment therebetween into a plurality of positions;
and
a pin assembly positioned within the inner tube and engaging the inner tube with the outer tube in the locked position to prevent relative rotation therebetween, the pin assembly disengaging the inner tube and the outer tube in the unlocked position to allow relative rotation.

16. A reclining seat as claimed in claim 15 wherein the inner tube includes opposing ends and a first aperture formed therethrough intermediate the opposing ends, the outer tube includes a plurality of rotationally offset second apertures therein, the spaced apart second apertures being rotationally offset to provide rotational adjustments of the outer tube relative to the inner tube.

17. A reclining seat as claimed in claim 16 wherein the pin assembly includes a pin extending outwardly through the first aperture in the inner tube and in the locked position the pin extends through an aligned second aperture.

18. A reclining seat as claimed in claim 15 wherein the inner tube includes opposing ends, a longitudinally extending row of first apertures formed therethrough intermediate the opposing ends, the outer tube including a row of longitudinally spaced apart second apertures extending between ends thereof in a rotationally offset pattern, the spaced apart second apertures being rotationally offset to provide rotational adjustments of the outer tube relative to the inner tube.

19. A reclining seat as claimed in claim 18 wherein the pin assembly includes a plurality of pins extending outwardly through the row of first apertures in the inner tube.

20. A reclining seat as claimed in claim 19 wherein the pin assembly includes a structure biasing the plurality of pins through the first apertures and into an aligned one of the second apertures.

21. A reclining seat as claimed in claim 20 wherein the structure biasing the plurality of pins includes a spring structure.

22. A reclining seat as claimed in claim 20 further including an operating structure positioned to move the pin assembly between an extended position and a retracted position, the operating structure moving the plurality of pins against the biasing structure in the retracted position.

23. A reclining seat as claimed in claim 18 wherein the outer tube includes a plurality of rows of second apertures.

24. A reclining seat as claimed in claim 23 wherein the inner tube includes a plurality of rows of first apertures.

25. A reclining seat as claimed in claim 18 wherein the outer tube includes a first portion and a second portion each being coaxially positioned around the opposing ends of the inner tube and rotatable relative thereto, the first portion and the second portion of the outer tube each include portions of the row of longitudinally spaced apart second apertures in a rotationally offset pattern.
